(19) United States
(12) Patent Application Publication
(10) Pub. No.: US 2016/0012258 A1
(43) Pub. Date: Jan. 14, 2016

(54) SYSTEM AND METHOD FOR SECURING AN INPUT/OUTPUT PORT USING SHAPE MEMORY ALLOYS IN A LOCKING MECHANISM

(71) Applicant: PORTAL LOCKS, LLC, Albuquerque, NM (US)

(72) Inventors: Karon Dale FOWLER, Dripping Springs, TX (US); Ceilidh Aoibheann CREECH, Dripping Springs, TX (US); Clifford B. MUNNS, Dripping Springs, TX (US)

(73) Assignee: PORTAL LOCKS, LLC, Albuquerque, NM (US)

(21) Appl. No.: 14/588,846

(22) Filed: Jan. 2, 2015

Related U.S. Application Data
(60) Provisional application No. 62/022,553, filed on Jul. 9, 2014.

(51) Int. Cl. G06F 21/82; G06F 21/32

(52) U.S. Cl. CPC G06F 21/82; G06F 21/32

(57) ABSTRACT

Described herein are systems and methods for securing and regulating access to physical input/output (“I/O”) ports on a computing or network device. Novel devices and methods for physically securing an I/O port using a memory shape alloy is disclosed. The compact form factors required in this application make the utilization of memory shape alloys particularly advantageous as they require minimal space.

### PRIORITY CLAIM

This application claims priority to U.S. Provisional Application Ser. No. 62/022,553 entitled “Portal Locks” filed Jul. 9, 2014, which is incorporated herein by reference in its entirety.

### STATEMENT REGARDING FEDERALLY SPONSORED RESEARCH OR DEVELOPMENT

No Federal grants sponsored any research or development relating to this application.

### BACKGROUND OF THE INVENTION

1. Field of the Invention

The invention generally relates to securing and regulating access to physical input/output (“I/O”) ports on a computing or network device.

2. Description of the Relevant Art

U.S. Pat. No. 8,827,331 issued to Corcoran et al. (hereinafter “Corcoran”) discloses “a small form factor latch utilizing shape memory alloy (SMA) actuators to implement computer-controlled retention of serviceable components.” Corcoran is directed to physically securing physical components of a computer to a computer chassis so that a given component is not mistakenly removed by a service technician. Corcoran is not directed to regulating access to a specific port. Corcoran does not disclose any means for specifically identifying a specific component. Corcoran does not disclose any authentication mechanisms for determining when a component should be released or whether to accept a new component,

U.S. Pat. No. 5,890,920 issued to David et al. (hereinafter “David I”) discloses “a closure device which projects from the side elements of the frame of a memory card connector to provide security for the memory card. The activation of the closure means is coordinated with the movement of the card eject plate so that after the card is inserted the connector cannot readily be tampered with to remove the card.” David I is directed only to external memory cards and is focused on a computer controlled ejection system. The reference does not teach any means for identifying the memory card. The reference further does not disclose any authentication systems or other means for determining whether to grant the external memory card access to the computer system. Notably, to the extent David I discusses restricting access, it is in the context of preventing a memory card from being forcibly removed, which is distinct from the present invention's teachings of an interface device that may not be forcibly removed.

U.S. Pat. Nos. 5,564,936, 5,573,413, and 5,597,316 issued to David et al. are all elaborations of the memory card ejection mechanism discussed in David I. U.S. Pat. No. 5,967,810 issued to Spickler et al. (hereinafter “Spickler”) also deals with similar subject matter. These references similarly fail to disclose at least the features discussed above with respect to David I.

U.S. Pat. No. 8,140,733 issued to Wong et al. (hereinafter “Wong”) discloses “[s]ecure external hubs for coupling peripheral devices to host computers are disclosed. Each peripheral device includes device identification (ID). Peripheral devices may be securely coupled to a host computer by designating authorized device IDs in response to an administrator input received via an administrator port of a hub, authorizing the peripheral devices connected to the hub based on the designated authorized device IDs, and enabling communication between authorized peripheral devices connected to the hub and a communication cable and preventing communication between unauthorized peripheral devices connected to the hub and the communication cable.” Wong, Abstract. In addition, Wong states: “Each peripheral device 30 includes information that may be used to identify a particular device or group of devices. The information may include Vendor ID, Product ID, Product Class, and serial number among others. Peripheral devices that comply with the USB specification are required to include such information and, thus, the secure hub 102 is particularly well suited to use with USB peripheral devices. Particular information for identifying authorized devices or groups of devices based on one or more pieces of the stored information is referred to herein as the device ID.” Wong, 3:3-12.

U.S. Pat. No. 6,745,330 issued to Maillot (hereinafter “Maillot”) discloses “To provide a more manageable security system for protecting cable-connected peripheral devices, a computer system is described having a removable peripheral device that is connectable to the computer system via a flying lead and a plug and socket combination, characterized by a lock member that is movable under the control of software running on the computer system to release or secure the plug to the socket.” Malliot, Abstract.

U.S. patent application Ser. No. 11/580,269 (Publication No. US20070132551 A1) filed by Mozer et al. (hereinafter “Mozer”) discloses “a biometric information recognizer and a shape memory material. The biometric information recognizer recognizes biometric information (such as speech) and signals the shape memory material with a current. The current causes the shape memory material to change shape, thereby reconfiguring a mechanical device. Such mechanical device may include a lock. In such manner, the lock may be isolated from external tampering (such as physical stressing) yet receptive to biometric information for controlling access.” Mozer, Abstract.

### SUMMARY OF THE INVENTION

The disclosed system and apparatus provides multiple defensive barriers for protecting both systems and data from unauthorized access. The disclosed system and apparatus limits I/O port access to only legitimate users along with secure logging and monitoring features to mitigate potential threats. Integration with existing business procedures and processes further enhances security.

Currently available products do not provide authentication protection for the removal of port locks, configuration control, or monitoring. Many of these products can be removed with commonly available tools or with standard keys common to the devices, which are readily available by purchasing one of their units. In contrast, the present invention requires individualized authentication of a user or connected device, providing a much more robust and fine grained level of security. The claimed invention has several aspects. One aspect provides physical protection for unused I/O ports. Another aspect provides physical protection for ports that are in use. Another aspect is that the invention is physically secured to the I/O ports via a latch fashioned out of a memory shape alloy or equivalent. A further aspect is that the latch is controlled in part by a circuit that provides authentication functionality. The claimed invention may optionally interface with software that provides logistical, logging, monitoring, and other functionality.

The E-Government Act of 2002 (Public Law 107-347), passed by the one hundred and seventh Congress and signed into law by the President in December 2002, recognized the importance of information security to the, entitled the Federal Information Security Management Act (“FISMA”) of 2002, tasked NIST with the responsibility of developing security standards and guidelines.

FIPS Publication 199, Standards for Security Categorization of Federal Information and Information Systems, approved by the Secretary of Commerce economic and national security interests of the United States. Title III of the E-Government Act in February 2004, is the first of two mandatory security standards required by the FISMA legislation. FIPS Publication 200, the second of the mandatory security standards, specifies minimum security requirements for information and information systems supporting the executive agencies of the Federal Government and a risk-based process for selecting the security controls necessary to satisfy the minimum security requirements. To comply with Federal standards, organizations first determine the security category of their information system in accordance with FIPS Publication 199, Standards for Security Categorization of Federal Information and Information Systems, derive the information system impact level from the security category in accordance with FIPS 200, and then apply the appropriately tailored set of baseline security controls in NIST Special Publication 800-53, Security and Privacy Controls for Federal Information Systems and Organizations. FIPS 200 and NIST Special Publication 800-53, in combination, ensure that appropriate security requirements and security controls are applied to all federal information and information systems.

The Presidential Policy Directive/PPD-21 dated Feb. 12, 2013, on Critical Infrastructure Security and Resilience advances a national unity of effort to strengthen and maintain secure, functioning, and resilient critical infrastructure. It specifically states, “The Secretary of Homeland Security shall provide strategic guidance, promote a national unity of effort, and coordinate the overall Federal effort to promote the security and resilience of the Nation's critical infrastructure.” A key responsibility assigned in the Homeland Security Act of 2002 is to identify and prioritize critical infrastructure, considering physical and cyber threats, vulnerabilities, and consequences. This directive identifies the following 16 critical infrastructure sectors and designates the associated Federal Sector-Specific Agencies (SSAs): Chemical; Commercial Facilities; Communications; Critical Manufacturing; Dams; Defense Industrial Base; Emergency Services; Energy; Financial Services; Food and Agriculture; Government Facilities; Healthcare and Public Health; Information Technology; Nuclear Reactors, Materials, and Waste; Transportation Systems; and Water and Wastewater Systems.

The disclosed invention will meet or exceed these regulatory requirements. Advantages include the ability to protect data from theft and insider misuse and protect against the spread of key cyber threats such as, DDoS attacks Worms, Trojan Horses, Spyware, Botnets, Phishing, etc. that may be transferred during the use of portable devices.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1 illustrates an embodiment with an I/O port connector configured to work with a USB port.

FIG. 2 illustrates an embodiment with an additional I/O port connector which allows to device to sit between an I/O and a connected device.

FIG. 3 is a high level view of the components in one embodiment.

FIG. 4 is a top down view of one embodiment.

FIG. 5 illustrates an embodiment adapted for use with a serial I/O port.

FIG. 6 illustrates an embodiment adapted for use with an RJ-45 I/O port.

FIG. 7 illustrates an embodiment adapted for use with a Fiber I/O port.

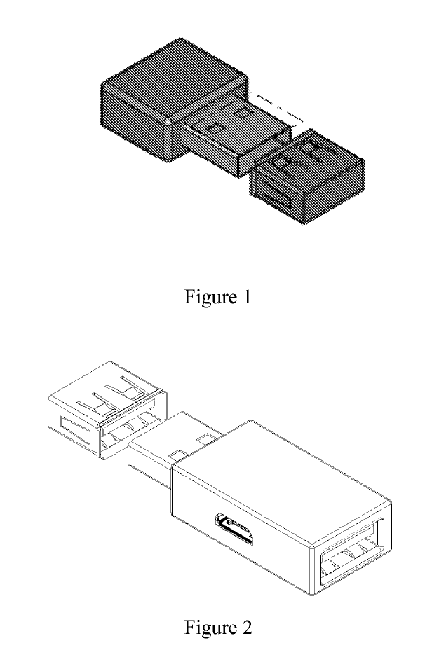

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

Physical I/O ports are physical interfaces to which one can connect a device and through which data may be communicated. Non-limiting examples of physical I/O ports include serial, parallel, Ethernet, FireWire, Universal Serial Bus, eSATA, Thunderbolt, Lightning, DisplayPort, Fiber Channel, High-Definition Multimedia Interface, Digital Visual Interface, Serial Digital Interface, S/PDIF, fiber optic, coaxial, RJ-45, RS-232, RS-422, and IEEE1394. These examples include all existing variants of the aforementioned standards and future variants, for example Universal Serial Bus may refer to USB 1.0, USB 2.0, USB 3.0, and any other variant of the Universal Serial Bus standard. As used in this specification, I/O port connector refers to a connector designed to connect to a physical I/O port. A given physical I/O port or I/O port connector may support more than one physical interface, for example, a Thunderbolt port or connector may also support Fiber Channel.

Furthermore, the use of the term “male” and “female” in the claims and this specification refer to their commonly understood usage in the art when referring to I/O port connectors. Each half of a pair of mating I/O port connectors is conventionally assigned the designation male or female. The female connector is generally a receptacle that receives and holds the male connector. If a particular port connector design does not have a male or female physical form, then, for purposes of this disclosure, the terms male and female are used simply to distinguish between the two physical sides of a connection and are interchangeable. Signals sent across a mated (connected) pair of I/O port connectors may be one-directional or bi-directional. The signals sent across a mated pair of I/O port connectors may encode information and the signal may take any physical form adapted for this purpose, e.g., electrical waves, light waves, etc. Signals sent across a mated pair of I/O port connectors may also include electrical current used to power a connected device.

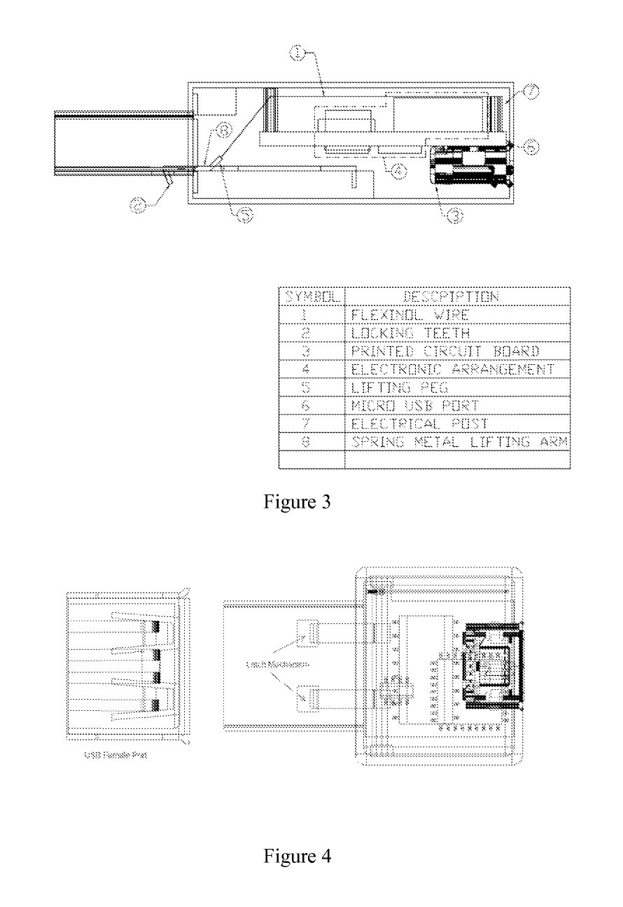

One skilled in the art will appreciate that a variety of locking mechanisms may be adapted for use with the disclosed invention. Regardless of the precise layout, any locking mechanism used within the disclosed invention must be adapted to, when locked, secure an I/O port connector to the complementary port connector to which it is mated. To be clear, when the I/O port is secured in this manner, it cannot be physically removed from the mated port. The locking mechanism is adapted to either male or female I/O port connectors. One example of such a mechanism is depicted in FIGS. 3 and 4.

The locking mechanism may include elements incorporating one or more memory shape alloys (discussed in detail below). The locking mechanism may include a metal spring steel device with extensions that go into the connected to I/O port when inserted.

The controller circuit is configured to lock or unlock the locking mechanism. The controller circuit may accomplish this directly or indirectly. In some embodiments, the controller circuit may cause the locking mechanism to lock or unlock via a physical connection. This physical connection may be constructed out of a memory shape alloy, as discussed further below. The controller circuit is configured to alter the shape of the shape memory alloy. This may be accomplished by, for example, applying an electrical current or directly heating the shape memory alloy. Additionally, to enhance operational security, as further elaborated on below with respect to the authentication circuit, the controller circuit may store certain authentication information or aspects of the authentication scheme, such as the mathematical operators used in the authentication scheme.

An authentication port allows an external device to transmit authentication information to the claimed invention. The authentication port may be of proprietary or standardized design, e.g., USB-compatible. A device such as a thumbprint scanner may be connected to various embodiments via the authentication port. Some embodiments may permit one or more of the I/O port connectors to function as an authentication port.

In some embodiments the authentication circuit is implemented so that no user or system can directly access the values stored within the circuit. In such embodiments, the circuit takes in input from the authentication port and, based upon the input, outputs commands to the controller circuit. In some embodiments the authentication circuit includes controller circuit functionality. Some embodiments includes circuitry which generates predetermined or pseudo-random (i.e., random but deterministic) sequences for use in one or more authentication schemes.

The authentication circuit may implement any one of a variety of authentication methodologies. For example, the authentication circuit may store one or more values and compare the stored value against the value received via the authentication port. The one or more values may comprise identification or authentication information, for example a hardware identifier, such as a system BIOS number, a hash generated based upon system information, a hardcoded number, or any other identification scheme; a password set by a user or administrator; or biometric information, such as a finger print or retinal pattern. Another example is the authentication circuit may include a deterministic pseudo-random number generator and the circuit may compare the output of its pseudo-random number generator against the information is receives via the authentication port. Any comparison compatible with a given authentication scheme is permissible. For example, a scheme that takes the stored values, performs mathematical operations on the stored values, then compares the result of those mathematical operations with the value(s) received from the authentication port, would still constitute a comparison as understood in this disclosure. Similarly, a scheme that performs mathematical operations on both the stored values and the values received from the authentication port and then compares the results of some or all of the mathematical operations would also constitute a comparison as understood in this disclosure.

The ability to use mathematical operations in this context is advantageous because it allows one to create a scheme such that the manufacturer of the individual components cannot ascertain the values needed to successfully authenticate a device. For example, the manufacturer of the authentication circuit may be given a value to burn into the authentication circuit, but is not given the set of mathematical operations performed on the value in order to generate the final value used for comparison and authentication. Thus, even though this particular manufacturer is in possession of a value necessary in the authentication scheme, it would be unable to use this knowledge to create unauthorized devices capable of passing the claimed authentication procedure. In this way operational security may be further enhanced even when using third party contractors to fabrication portions of an embodiment.

Certain embodiments store values for use by the authentication circuit in executing an authentication scheme. For example, some embodiments may have an identification number hardcoded into the device and which may not be altered after being set.

To further increase security, the preferred embodiment includes a separate circuit, independent of the controller circuit and the authentication circuit, which stores one or more values used by the authentication circuit in the authentication scheme. The stored values may be permanently burned into the chip or the values may be rewritable. In the preferred embodiment the values are permanently burned into the circuit. As noted previously, by separating out values and mathematical operators used, operational security is increased because no outside entity is in possession of all the elements required to implement or subvert the authentication scheme. In a similar vein, the authentication circuit may also utilize values or other information located in the controller circuit in order to effectuate the authentication scheme. Again, by compartmentalizing elements of the authentication scheme on different parts of the device and not allowing any one entity to manufacture all the different parts, no one outside entity has knowledge sufficient to replicate the authentication scheme.

Similarly, in some embodiments portions of the authentication scheme may be located on the device connected to the authentication port. Further, to enhance security, aspects of the authentication scheme may be further subject to encryption, e.g., the values stored on the separate chip may be encrypted before being provided to the authentication circuit. One skilled in the art will recognize that a variety of cryptographic techniques may be employed, for example AES encryption.

Shape memory alloys (SMAs) are metals that “remember” their original shapes. SMAs may be used as actuators, which are materials that change shape, stiffness, position, natural frequency, and other mechanical characteristics in response to temperature or electromagnetic fields. Shape memory alloys include nickel-titanium, copper-aluminum-nickel, copper-zinc-aluminum, and iron-manganese-silicon alloys. The generic name for the family of nickel-titanium alloys is Nitinol. In 1961, Nitinol, which stands for Nickel Titanium Naval Ordnance Laboratory, was discovered to possess the unique property of having shape memory.

The properties of Nitinol and other SMAs are particular to the exact composition of the metal and the way it was processed. The physical properties of Nitinol include a melting point around 1240° C. to 1310° C., and a density of around 6.5 g/cm³. Various other physical properties tested at different temperatures with various compositions of elements include electrical resitivity, thermoelectric power, Hall coefficient, velocity of sound, damping, heat capacity, magnetic susceptibility, and thermal conductivity. Mechanical properties tested include tensile strength, shear strength, hardness, impact toughness, fatigue strength, and machinability.

SMAs may be formed into actuator wires that contract when electrically driven or heated. Flexinol® is a trade name for one such shape memory alloy actuator wire. Flexinol is made of nickel-titanium alloy and is formed into a small diameter wire and contract (typically 2% to 5% of their length) like muscles when electrically driven or heated. This ability to flex or shorten is a characteristic of certain shape memory alloys, which dynamically change their internal structure at certain temperatures. Some SMAs, such as Flexinol, contract by several percent of their length when heated and can then be easily stretched out again as they cool back to ambient temperature.

One advantage of SMA-based actuators, such as Flexinol, is that they are compact and can be incorporated into small devices.

For ease of reading, any reference to a “port” in the written description refers to a physical I/O port, as opposed to a virtual I/O port, unless otherwise noted.

One preferred embodiment is a port insert that may be locked or unlocked using an electronic password. The embodiment can be used to block USB, Serial, Parallel, RJ 45 (Ethernet), Fiber Optic, or other physical I/O ports. Physical locking of a port is a method to thwart cyber attacks through unused ports having access to the digital devices. Physical locking is achieved using a port insert device that will fit in or cover a physical I/O port. Part of the insert is an I/O port connector designed to interface with the physical I/O port. The embodiment has a lock mechanism which securely holds the device in place. Controller circuit locks or unlocks the locking mechanism. The controller circuit is directed to lock or unlock the locking mechanism by an authentication circuit. The authentication circuit includes a chip which stores an identification number that is associated with either the physical locking device or the computer to which the physical locking device is attached.

This preferred embodiment further includes a port through which authentication information—a non-limiting example is a password—is communicated. In this preferred embodiment a user may use the port to enter the authentication information via the authentication port. This may be accomplished using a hand held touch screen, keypad, or other any other portable device that can connect and transmit authentication information to the authentication port. When the authentication circuit receives authentication information, it compares the authentication information to the stored number and determines whether to lock or unlock the lock based upon the comparison. The comparison may be based on a variety of methodologies, including comparing the authentication information to the number to see if they match or performing mathematical operations on the authentication information and comparing the results of the mathematical operation to another value. These comparison methodologies may be implemented by any technique well known in the art, such as binary comparison operators.

The locking mechanism consists of a mechanical connection to the controller circuit though an actuator wire made of a suitable SMA and to a latch which will extend into the physical I/O port when not in an energized state, thereby engaging the lock. When in the energized state, the latch will lift out of certain holes in the physical I/O port, disengaging the lock and thereby allow the removal of the port insert. The mechanical movement of the latch is controlled by the application of an electrical current from the controller circuit to the actuator wire, which causes the actuator wire to contract and thereby move the latch assembly. Other means for causing the wire to contract, such as the direct application of heat to the wire, are also permissible. One skilled in the art will recognize that the locking mechanism can also be implemented in the reverse manner wherein the contraction of the wire locks the latch rather than unlocks.

If the authentication circuit approves the authentication information, it directs the controller circuit to unlock the locking mechanism.

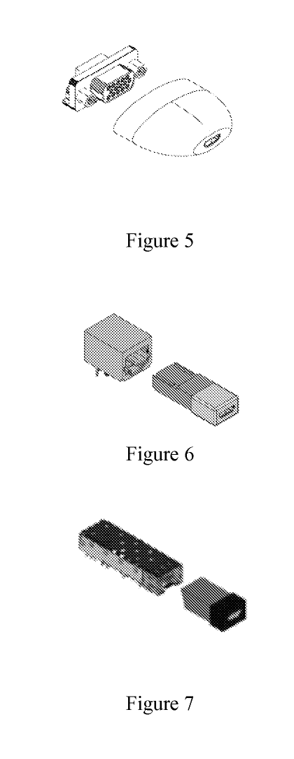

Other embodiments operate in a similar manner but are physically adapted to interface with different port designs. FIGS. 5 through 7 depicts several non-limiting examples of the device adapted to work with serial, parallel, RJ-45, and fiber optic ports.

Additionally, while the preferred embodiment utilizes Flexinol in its actuator wire, any other shape memory alloy, whether in wire form, or any other form that can be expanded or contracted may also be employed. It will be apparent to one skilled in the art that alternative implementations of the locking mechanism may utilize the shape memory alloy actuator differently. For example, the tension of the latch and the orientation of the actuator wire may be configured such that contracting the actuator wire causes the latch to lock rather than unlock. A further example is a mechanism wherein the actuator wire need only be locked momentarily to effect a lasting change in the latch's position.

Another preferred embodiment contains a pass through port which allows the port insert to interface with both the physical I/O port that it is protecting as well as a device that would normally be connected directly to that port. This embodiment is similar to the previous preferred embodiment, with several additions. As previously noted, this embodiment it contains a pass through port. The pass through port is communicably connected to the I/O port connector, which allows for data to be transmitted between the device connected to the pass through port and the I/O port. In addition, the authentication circuitry may cause the transmission of data between the two ports to be blocked if it determines that the current use is not authorized. This determination may based on the same authentication procedure used to physically secure the I/O port, or may be a separate authentication procedure with differing criteria.

One advantage of this embodiment is that it allows for the port to be used while the port insert monitors the device connected to the pass through port's usage, granting or denying access to the port as needed. If the current device is removed from the pass through port, access will be denied until valid authentication information, e.g., a password, is received by the authentication circuit. This effectively prevents a cyber attack vector though the active physical I/O ports of a given system.

FIG. 2 depicts this preferred embodiment. Other embodiments will be identical in the operation and similar in configuration of the device, except that their connector port and/or pass through port may adapted to interface with various types of connections, e.g., USB, FireWire, etc. It should be noted that the pass through port and connector port do not have to be of the same type or of opposite gender. For example, an embodiment may have a connector port adapted for USB but a pass through port adapted to receive FireWire connections. An embodiment may also have any combination of male or female adapters. Port designs that do not have a male or female configuration are also claimed, in which case the usage of those terms there is merely descriptive and used to help distinguish one port from another. In embodiments where the ports do not match, additional standard circuitry well known in the art may be added to enable the requisite signal modifications to allow for the transfer of data. Additionally, the transfer of data between the ports may be unidirectional or bilateral, depending on the configuration of the port insert and the access permitted by the authentication circuit.

1-45. (canceled)

46. A device for securing a physical I/O port, comprising:
an I/O port adapter;
a locking mechanism, wherein the locking mechanism is adapted to, when locked, physically secure the I/O port adapter to the physical I/O port;
a controller circuit, wherein the controller circuit is configured to operate the locking mechanism to lock, unlock, or remain in its current state; further wherein the controller circuit is physically connected to the locking mechanism and the physical connection comprises a memory shape alloy.

47. The device of claim 46, further comprising an authentication circuit and wherein the controller circuit operates the locking mechanism to lock or unlock as a result of a signal from the authentication circuit.

48. The device of claim 46, wherein the physical connection comprises a memory shape alloy, including but not limited to nitinol or Flexinol.

49. The device of claim 48, wherein the controller circuit applies an electrical current to the memory shape alloy.

50. The device of claim 49, wherein the size or shape of the memory shape alloy changes in response to the electrical current.

51. The device of claim 50, wherein the change in the size or shape of the memory shape alloy causes the locking mechanism to lock or unlock.

52. The device of claim 46, wherein each of the I/O port adapters supports serial, parallel, Ethernet, FireWire, Universal Serial Bus, eSATA, Thunderbolt, DisplayPort, Fibre Channel, High-Definition Multimedia Interface, Digital Visual Interface, Serial Digital Interface, S/PDIF, fiber optic, coaxial, RJ-45, RS-232, RS-422, IEEE1394, or any other interface designed to allow transmission of data.

53. The device of claim 46, wherein the latching mechanism is compatible with the physical port layout of the physical I/O port.

54. The device of claim 46, wherein the I/O port adapter may be male or female.
